(19) United States
(12) Patent Application Publication
(10) Pub. No.: US 2025/0265747 A1
(43) Pub. Date: Aug. 21, 2025

(54) SYSTEMS AND METHODS FOR REPRESENTING RELATIONAL AFFECT IN HUMAN GROUP INTERACTIONS

(71) Applicant: Honda Motor Co., Ltd., Tokyo (JP)

(72) Inventors: Nawid JAMALI, San Francisco, CA (US); Nina M. MOORMAN, Atlanta, GA (US); Hifza JAVED, San Jose, CA (US)

(21) Appl. No.: 18/443,206

(22) Filed: Feb. 15, 2024

(51) Int. Cl. G06T 11/20; G06V 20/40; G06V 40/10

(52) U.S. Cl. CPC G06T 11/206; G06V 20/41; G06V 20/46; G06V 40/10

(57) ABSTRACT

Systems and methods for generating a graph of group affect are provided. The system receives a video of a group of individuals from a video source and extracts a feature that includes data for determining group affect. The system identifies, from the group of individuals, a first individual associated with the feature. The system determines a first node, in a graph, that is associated with the first individual and stores the feature associatively with the first node when the feature is associated only with the first individual. The system identifies a second individual associated with first individual and the feature, and determines second node, in the graph, that is associated with the second individual. The system generates an edge in the graph associated with the first node and the second node, and stores the feature associatively with the edge.

### BACKGROUND

Interactions between people in group situations may be analyzed to determine group dynamics and relational affect of individuals in the group. Interactions may be influenced by factors such as an individual's emotional reaction to a topic being discussed, an individual's mood or the mood of the group, personal relationships between individuals, and other group dynamics. A change in the contextual situation of the group may affect interactions. A work environment may produce a much different interaction than a social gathering, even between the same individuals in the same group.

Group interactions may be recorded using video capture devices. Interactions between individuals in a group may be analyzed by processing images and audio extracted from video from video capture devices. The interactions may be analyzed in real time or analyzed by processing previously recorded video clips. Storing captured data and/or processed information about the interactions in a suitable data format may facilitate analysis by other systems or processes.

### BRIEF DESCRIPTION

According to one embodiment, a system for representing relational affect is provided. The system includes an image processor that receives video of a group of individuals from a video source. The system extracts, from the video, a feature that includes data for determining group affect. The system identifies one or more individuals from the group that are associated with the feature. A graph processor determines whether a node in a graph is identified with an individual and stores the feature with that node when the feature is associated only with that individual. The graph processor generates an edge in the graph when the feature is also associated with a second individual and a second node.

According to another embodiment, a method for outputting a relational affect graph is provided. The method includes receiving a video of a group of individuals from a video source, and extracting, from the video, a feature that includes data for determining group affect. The method further includes identifying one or more individuals from the group that are associated with the feature, and determining whether a node in a graph is associated with the individual. The method further includes storing the feature with that node when the feature is associated only with that individual. The method may include generating an edge in the graph when the feature is also associated with a second individual and a second node.

According to yet another embodiment, a non-transitory computer readable storage medium storing instructions that, when executed by a computer having a processor, cause the computer to perform a method for generating a graph of group affect. The method includes receiving a video of a group of individuals from a video source, and extracting, from the video, a feature that includes data for determining group affect. The method further includes identifying one or more individuals from the group that are associated with the feature, and determining whether a node in a graph is associated with the individual. The method further includes storing the feature with that node when the feature is associated only with that individual. The method may include generating an edge in the graph when the feature is also associated with a second individual and a second node.

### BRIEF DESCRIPTION OF THE DRAWINGS

FIG. 1 is an exemplary framework diagram of a system for generating a graphical model of group relational affect, according to one aspect.

FIG. 2A is a first exemplary graph, according to one aspect.

FIG. 2B is a second exemplary graph, according to one aspect.

FIG. 3 is an exemplary process flow of a method for feature extraction, according to one aspect.

FIG. 4 an exemplary process flow of a method for graphical representation, according to one aspect.

FIG. 5 an exemplary process flow of a method for determining group relational affect from a graphical representation, according to one aspect.

FIG. 6 is an illustration of an example computer-readable medium or computer-readable device including processor-executable instructions configured to embody one or more of the provisions set forth herein, according to one aspect.

FIG. 7 is an illustration of an example computing environment where one or more of the provisions set forth herein are implemented, according to one aspect.

### DETAILED DESCRIPTION

The systems and methods herein provide the ability to output detailed relational data from group interactions captured from various input modalities including video streams. The detailed relational data may be stored in a suitable data format, for example a graph that is generated to store raw and/or processed information about individuals, groups, and interactions as described in greater detail below. Detailed graphical data about group interactions may be used, for example, by a downstream system to model group dynamics, to modify individual or group behaviors, or to make determinations for performing tasks.

By capturing and analyzing group interactions, the systems and methods may determine the most effective modalities for affecting individuals or groups. Certain individuals or groups may be more strongly influenced by particular modalities of communication over other modalities. The systems and methods may recommend interactions that may be performed through any number of different means including but not limited to third party interactions with a group, instructions presented to one or more persons of the group, or even changing environmental conditions to modify individual behaviors or group dynamics.

The systems and methods may perform geometric deep learning of data stored in a graphical format. By modeling individuals explicitly as nodes in a graph, and interactions between individuals as edges between the nodes in the graph, the graph may be used to efficiently capture relational data about a large number of interactions between multiple different individuals. The graph captures group-level information in its entirely using graph embeddings, for example the graph edges stored as links between pairs of nodes, to detail the plurality of interactions between discrete individuals and/or among different subsets of individuals in a group. Furthermore, interactions are not limited to those occurring contemporaneously during one group interaction occurring at the same time and place, but instead may include multiple interactions occurring at different times, in different locations or situations, and between different subsets of individuals over any desired period, or periods, of time.

Storing data in a graph about various individuals and interactions is advantageous not only because a graph is open ended, but also because a graph easily lends itself to storing and analyzing information both about the individuals themselves and also about the interactions that occur between individuals. Information about individuals may be stored as nodes in the graph, while interactions between individuals may be further analyzed or characterized and then stored as embeddings, such as edges between nodes. The nodes of the graph that are representative of individuals may be updated and modified as additional data is collected and analyzed. As interactions between various individuals occur, the data and any associated or determined context about the interactions may be stored as additional edges between nodes in the graph, or added to existing edges as appropriate. Additionally, edges may be added through any suitable message passing between operating modules and may be independent of when interactions actually occur. This feature advantageously facilitates the storing of additional data determined through post processing of the interactions, by this or other systems, that have been previously stored in the graph.

The data stored in the graphical representation may be output to a separate data store or provided to downstream systems. The data may be accessed and used by downstream systems through queries of the system or directly by any other suitable system that has access to the graphical representation of the data. The data may be analyzed and used to generate tasks for the downstream systems to dynamically alter group dynamics or perform other suitable tasks.

### Definitions

The following includes definitions of selected terms employed herein. The definitions include various examples and/or forms of components that fall within the scope of a term and that may be used for implementation. The examples are not intended to be limiting. Furthermore, the components discussed herein, may be combined, omitted, or organized with other components or into different architectures.

“Bus,” as used herein, refers to an interconnected architecture that is operably connected to other computer components inside a computer or between computers. The bus may transfer data between the computer components. The bus may be a memory bus, a memory processor, a peripheral bus, an external bus, a crossbar switch, and/or a local bus, among others. The bus may also be a bus that interconnects components inside an agent using protocols such as Media Oriented Systems Transport (MOST), Controller Area Network (CAN), Local Interconnect network (LIN), among others.

“Component,” as used herein, refers to a computer-related entity (e.g., hardware, firmware, instructions in execution, combinations thereof). Computer components may include, for example, a process running on a processor, a processor, an object, an executable, a thread of execution, and a computer. A computer component(s) may reside within a process and/or thread. A computer component may be localized on one computer and/or may be distributed between multiple computers.

“Computer communication,” as used herein, refers to a communication between two or more communicating devices (e.g., computer, personal digital assistant, cellular telephone, network device, vehicle, computing device, infrastructure device, roadside equipment) and may be, for example, a network transfer, a data transfer, a file transfer, an applet transfer, an email, a hypertext transfer protocol (HTTP) transfer, and so on. A computer communication may occur across any type of wired or wireless system and/or network having any type of configuration, for example, a local area network (LAN), a personal area network (PAN), a wireless personal area network (WPAN), a wireless network (WAN), a wide area network (WAN), a metropolitan area network (MAN), a virtual private network (VPN), a cellular network, a token ring network, a point-to-point network, an ad hoc network, a mobile ad hoc network, a vehicular ad hoc network (VANET), a vehicle-to-vehicle (V2V) network, a vehicle-to-everything (V2X) network, a vehicle-to-infrastructure (V2I) network, among others. Computer communication may utilize any type of wired, wireless, or network communication protocol including, but not limited to, Ethernet (e.g., IEEE 802.3), WiFi (e.g., IEEE 802.11), communications access for land mobiles (CALM), WiMax, Bluetooth, Zigbee, ultra-wideband (UWAB), multiple-input and multiple-output (MIMO), telecommunications and/or cellular network communication (e.g., SMS, MMS, 3G, 4G, LTE, 5G, GSM, CDMA, WAVE), satellite, dedicated short range communication (DSRC), among others.

“Communication interface” as used herein may include input and/or output devices for receiving input and/or devices for outputting data. The input and/or output may be for controlling different agent features, which include various agent components, systems, and subsystems. Specifically, the term “input device” includes, but is not limited to: keyboard, microphones, pointing and selection devices, cameras, video streaming devices, imaging devices, video cards, displays, push buttons, rotary knobs, and the like. The term “input device” additionally includes graphical input controls that take place within a user interface which may be displayed by various types of mechanisms such as software and hardware-based controls, interfaces, touch screens, touch pads or plug and play devices. An “output device” includes, but is not limited to, display devices, and other devices for outputting information and functions.

“Computer-readable medium,” as used herein, refers to a non-transitory medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device may read.

“Database,” as used herein, is used to refer to a table. In other examples, “database” may be used to refer to a set of tables. In still other examples, “database” may refer to a set of data stores and methods for accessing and/or manipulating those data stores. In one embodiment, a database may be stored, for example, at a disk, data store, and/or a memory. A database may be stored locally or remotely and accessed via a network.

“Data store,” as used herein may be, for example, a magnetic disk drive, a solid-state disk drive, a floppy disk drive, a tape drive, a Zip drive, a flash memory card, and/or a memory stick. Furthermore, the disk may be a CD-ROM (compact disk ROM), a CD recordable drive (CD-R drive), a CD rewritable drive (CD-RW drive), and/or a digital video ROM drive (DVD ROM). The disk may store an operating system that controls or allocates resources of a computing device.

“Display,” as used herein may include, but is not limited to, LED display panels, LCD display panels, CRT display, touch screen displays, among others, that often display information. The display may receive input (e.g., touch input, keyboard input, input from various other input devices, etc.) from a user. The display may be accessible through various devices, for example, though a remote system. The display may also be physically located on a portable device, mobility device, or host.

“Logic circuitry,” as used herein, includes, but is not limited to, hardware, firmware, a non-transitory computer readable medium that stores instructions, instructions in execution on a machine, and/or to cause (e.g., execute) an action(s) from another logic circuitry, module, method and/or system. Logic circuitry may include and/or be a part of a processor controlled by an algorithm, a discrete logic (e.g., ASIC), an analog circuit, a digital circuit, a programmed logic device, a memory device containing instructions, and so on. Logic may include one or more gates, combinations of gates, or other circuit components. Where multiple logics are described, it may be possible to incorporate the multiple logics into one physical logic. Similarly, where a single logic is described, it may be possible to distribute that single logic between multiple physical logics.

“Memory,” as used herein may include volatile memory and/or nonvolatile memory. Non-volatile memory may include, for example, ROM (read only memory), PROM (programmable read only memory), EPROM (erasable PROM), and EEPROM (electrically erasable PROM). Volatile memory may include, for example, RAM (random access memory), synchronous RAM (SRAM), dynamic RAM (DRAM), synchronous DRAM (SDRAM), double data rate SDRAM (DDRSDRAM), and direct RAM bus RAM (DRRAM). The memory may store an operating system that controls or allocates resources of a computing device.

“Module,” as used herein, includes, but is not limited to, non-transitory computer readable medium that stores instructions, instructions in execution on a machine, hardware, firmware, software in execution on a machine, and/or combinations of each to perform a function(s) or an action(s), and/or to cause a function or action from another module, method, and/or system. A module may also include logic, a software-controlled microprocessor, a discrete logic circuit, an analog circuit, a digital circuit, a programmed logic device, a memory device containing executing instructions, logic gates, a combination of gates, and/or other circuit components. Multiple modules may be combined into one module and single modules may be distributed among multiple modules.

“Operable connection,” or a connection by which entities are “operably connected,” is one in which signals, physical communications, and/or logical communications may be sent and/or received. An operable connection may include a wireless interface, firmware interface, a physical interface, a data interface, and/or an electrical interface.

“Portable device,” as used herein, is a computing device typically having a display screen with user input (e.g., touch, keyboard) and a processor for computing. Portable devices include, but are not limited to, handheld devices, mobile devices, smart phones, laptops, tablets, e-readers, smart speakers. In some embodiments, a “portable device” could refer to a remote device that includes a processor for computing and/or a communication interface for receiving and transmitting data remotely.

“Processor,” as used herein, processes signals and performs general computing and arithmetic functions. Signals processed by the processor may include digital signals, data signals, computer instructions, processor instructions, messages, a bit, a bit stream, that may be received, transmitted and/or detected. Generally, the processor may be a variety of various processors including multiple single and multicore processors and co-processors and other multiple single and multicore processor and co-processor architectures. The processor may include logic circuitry to execute actions and/or algorithms.

### I. System Overview

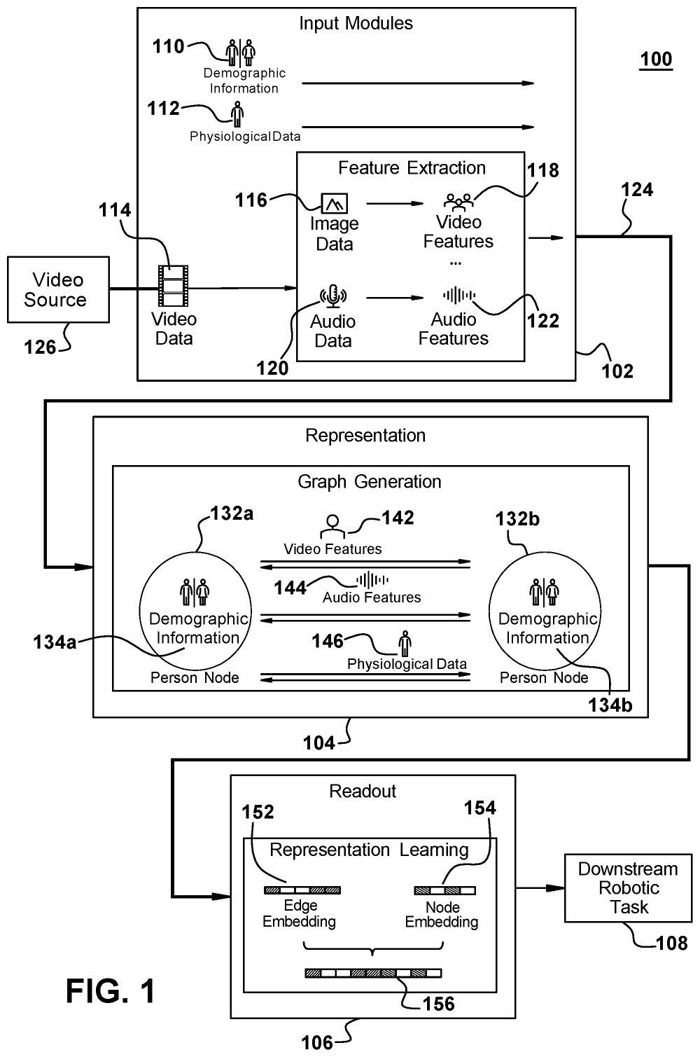

The drawings are intended for purposes of illustrating one or more exemplary embodiments and not for purposes of limiting the same. FIG. 1 is an exemplary diagram of a system framework 100 for generating a graph of relational affect in human group interactions, according to one aspect. The framework 100 includes an input module 102, a representation module 104, and an output module 106 for outputting to one or more downstream systems 108.

The input module 102 may be configured to accept various types of information. The input module 102 may process the received information into features. The input module 102 provides the information to the representation module 104. For example, the input module 102 may receive a video stream 114. The video stream 114 may be processed to extract one or more clips from the video stream 114. The video stream 114 or individual clips may be processed to extract image data 116, for example a series of individual images, frames or pictures from the video stream 114. The video stream 114 may be received from any suitable video source 126 including but not limited to a video camera or a plurality of video cameras, video capture devices, live video streaming devices, or one or more previously recorded video streams.

The image data 116 may be processed to determine one or more video features 118. Example video features 118 may include indicia that indicate which individual is speaking, to whom the individual is speaking (for example a group of people or one or more other individuals), the direction that the individual is facing, facial features, and so forth. As an example, the direction of an individual's gaze may be analyzed and determined by examining the individual's eyes in a single image, by analyzing a sequence of images, or by analyzing images from a plurality of sources.

Image data 116 may be processed to determine if the individual is responding to another person, or to determine which person or persons the individual is directing their speech. The image data 116 may be processed to determine the facial expressions of one or more of the individuals from the video stream 114, for example to determine if an individual is, for example, angry, smiling, paying attention, bored, distracted, or any other discernable feature.

The video stream 114 may also be processed to extract audio data 120, for example by splitting audio into streams based on which individual is speaking, or based on conversations between people. Audio may be separated into multiple individual segments based on any suitable criteria or technological means, including but not limited to machine learning or suitable Al algorithms. The audio data 120 may be processed to determine one or more audio features 122. Audio features 122 may include indications as to which individual is speaking or which individuals are speaking, volume, tone, tonal inflections, pauses in speech, pacing or speed of speech, and so forth.

In another example, the input module 102 may provide demographic information 110 about individuals or groups of individuals to the representation module 104. Example demographic information 110 may include any suitable data such as information associated with their employment, which may include as non-limiting examples the company the individual is employed by, any department or division at that company, inclusion in any groups or teams, the individual's position or title, salary or compensation information and so forth. In embodiments, demographic information may also include personal work-related information such as educational background including any degrees conferred and associated titles such as Ph.D or J.D., familial status, etc. In embodiments, demographic information may also include personal identifying information that may be used by a system to identify the individual such as age, height, weight, hair color, facial hair, gender, race, whether an individual wears glasses or contacts, or has personal ornamentation such as earrings, tattoos, and so forth.

In another example, the input module 102 may provide physiological information 112 about individuals, groups of individuals, or the environment to the representation module 104. Example physiological information 112 may include any suitable data such as an individual's biometric data, or environmental conditions such as the temperature, lighting conditions in a room, or the local weather conditions. Biometric data may be derived from a wearable device on a person. Example wearable devices may include a watch or a fitness device that provides biometric sensor data such as heart rate, heart abnormalities, breath rate, temperature, indications of movement, and so forth.

The input module 102 may provide all or a subset of processed and/or raw data to the representation module 104 as a data stream 124. The data stream 124 may be asynchronous or synchronous. For example, the data stream 124 may receive each data as it is generated by input module 102. In another example, data in the data stream may be synchronized, for example video features 118 and audio features 122 associated with the same conversion may be identified as such and forwarded to the representation module 104.

The representation module 104 receives the data stream 124 from the input module 104 and performs operations to organize the received data from the data stream 124. In an embodiment, the representation module 104 organizes the received data and stores the data in a graph 130. For example, as illustrated in FIG. 1, each identified individual may be stored as a person node 132a, 132b (collectively person node 130) in the graph 130. Information particularized to each individual, such as demographic information 134a, 134b (collectively demographic information 134), may be stored associatively with the respective person node 132. Other received information may be stored as edges 140 of the graph 130. For example, a video feature 142 may be stored as an edge 140 between a first person node 132a and a second person node 132b as illustrated. An associated audio feature 144 and physiological feature may be similarly stored as independent edges 140. The edges 140 in this particular example may represent part of a conversation between an individual represented by the first person node 132a and another individual who is represented by the second person node 132b. In this example, the audio feature 144 may be the audible conversation that took place between the two individuals, the video feature 142 may be indicia derived from the video indicating that the two individuals were facing one another during part of the conversation, and the physiological feature 146 may be the individuals' respective biometric data from wearable devices temporally proximate to the detected conversation.

Continuing with the example presented above, storing received features and other data in a graph 130 by the representation module 104 provides certain advantages. First, data received by the representation module 104 may be dynamically stored in the graph 130 as it is received without requiring prior knowledge of the identities participants to be known by the system ahead of time. The graph 130 may be expanded, and data may be added, as data is received without requiring the system to know details about the data ahead of time. Different types of data such as video features 142, audio features 144, and physiological features 144 may not be concurrently received or temporally aligned.

For example, each time an individual speaks during a conversation, a different audio feature 144 may be generated and individually stored in the graph 130 as an edge 140. Using the same example, a video feature 142 indicating that two individuals were facing one another during the conversation may only occur during a subset of one part of a conversation. For example, the two individuals may first make eye contact some time after the conversation has initiated, for example only at the beginning of the conversation and thereafter only sporadically during parts of their conversation. Similarly, biometric data of the individuals sensed after a conversation has concluded may be a useful physiological feature 146 that is captured and stored in the graph 130. In related examples, received data may be received out of temporal order due to network or other system related latencies. In related examples, differences in sampling rates may result in data from some modalities being received more frequently than data from other modalities.

A second advantage of using a graph 130 to store the received data is that a graph 130 enables capturing the interactions of any suitable number of individuals over any suitable timeframe, for example on an ongoing basis. The number of individuals does not need to be known ahead of time and the captured interactions may occur over multiple temporally separate instances. Similarly, any suitable kinds of features and interactions may be extracted and captured from the underlying data and the features that are captured and stored may be expanded without obsoleting existing stored data in the graph 130. A dynamic graph 130 advantageously may capture how conversations and interactions between different people change over time. As more data is received via the data stream 124, additional nodes 132 and edges 140 may be added to the graph 130 thereby creating a robust dynamic graph 130 of any number of interactions of multiple different sets of individuals in different locations and at different points in time. The representation module 104 may use thresholds, algorithms, neural networks, or other suitable programming or heuristic determinants to determine when features are added to the graph 130.

The output module 106 may use any suitable graph algorithms, neural networks, programming, and so forth to analyze the stored node embeddings 154 and edge embeddings 152 in the graph 130 to generate output data 156. Output data 156 may include data about individuals, groups or subgroups of individuals, features, and relationships between various individual, groups, features, and so forth. In an embodiment, the graph 130 may be used by the output module 106 to generate and output data 156 delivered to a downstream system 108, for example a robotics platform. In another embodiment, the output module 106 may be queried by the downstream system 108 to generate desired output data 156 from the output module 106. In yet another embodiment, the output module 106 may permit direct access to the stored node embeddings 154 and edge embeddings 152 of the graph 130 by a downstream system 108.

The components of the framework 100, as well as the components of other systems, hardware architectures, and software architectures discussed herein, may be combined, omitted, or organized into different architectures for various embodiments. In an embodiment, the framework 100 may be implemented with one or more computing devices and associated software or firmware. In various embodiments, the components and functions of the framework 100 may be implemented, for example, on one or more networked devices, on portable devices connected via a network, and so forth. The framework 100 may be capable of providing wired or wireless computer communications utilizing various protocols to send/receive electronic signals internally to/from components of the operating framework 100. Additionally, the framework 100 may be operably connected for internal computer communications via a bus (e.g., a Controller Area Network (CAN) or a Local Interconnect Network (LIN) protocol bus) to facilitate data input and output between the components of the framework 100.

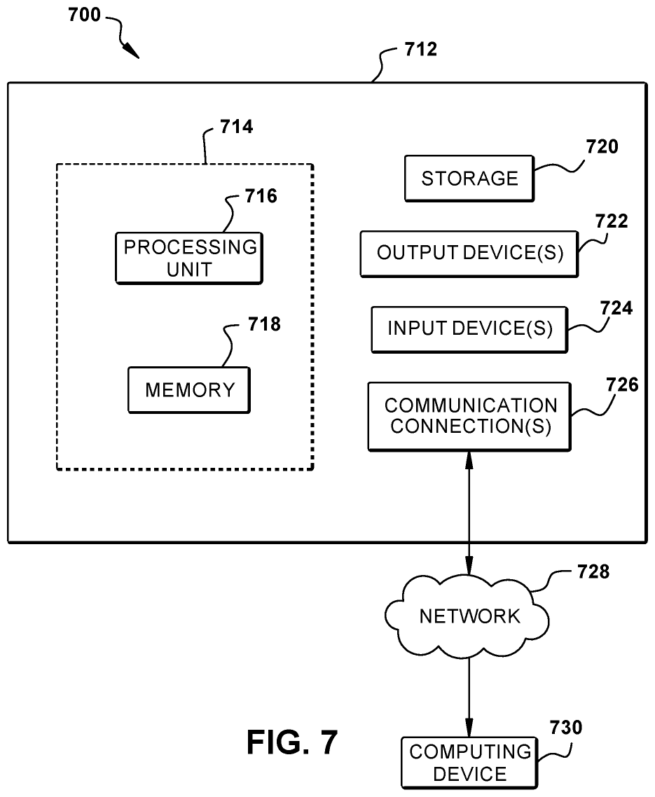

Referring now also to FIG. 7, an example system 700 for implementing the framework 100 is presented. Individual components of the system 700 are described in greater detail at the end of this document. The system 700 includes an apparatus 712 having processing unit 716, a memory 718, a data store or storage 720, and a communication interface, or communication connection 726, which are each operably connected for computer communication via a bus and/or other wired and wireless technologies.

The apparatus 712 executes instructions comprising the input module 102, the representation module 104, and the output module 106. One or more of the input module 102, the representation module 104, and the output module 106 may be implemented in part or in whole using one or more neural networks that implement machine learning which may include deep learning. Example neural networks include dynamic graph neural networks (GNN), temporal recurrent networks (TRN), convolution neural networks (CNN) and conditional generative adversarial networks (cGAN). Components of a neural network may include an input layer, an output layer, and one or more hidden layers, which may be convolutional filters. In embodiments, one or more processing units 716 of the apparatus 712 is an image processor. In these embodiments, the image processor may be a hardware implementation in a specialized processing unit 716, or the image processor may be a software implementation with suitable computer instructions that when executed perform the image processing and which may include one or more algorithms or neural networks as described above.

The apparatus 712 is operably connected for communication with other computing devices 730, such as the downstream system 108, via a network 728 through the communication connection 726. The apparatus 712 may store the graph 130 locally in storage 720 or export the graph to a remotely connected computing device 730.

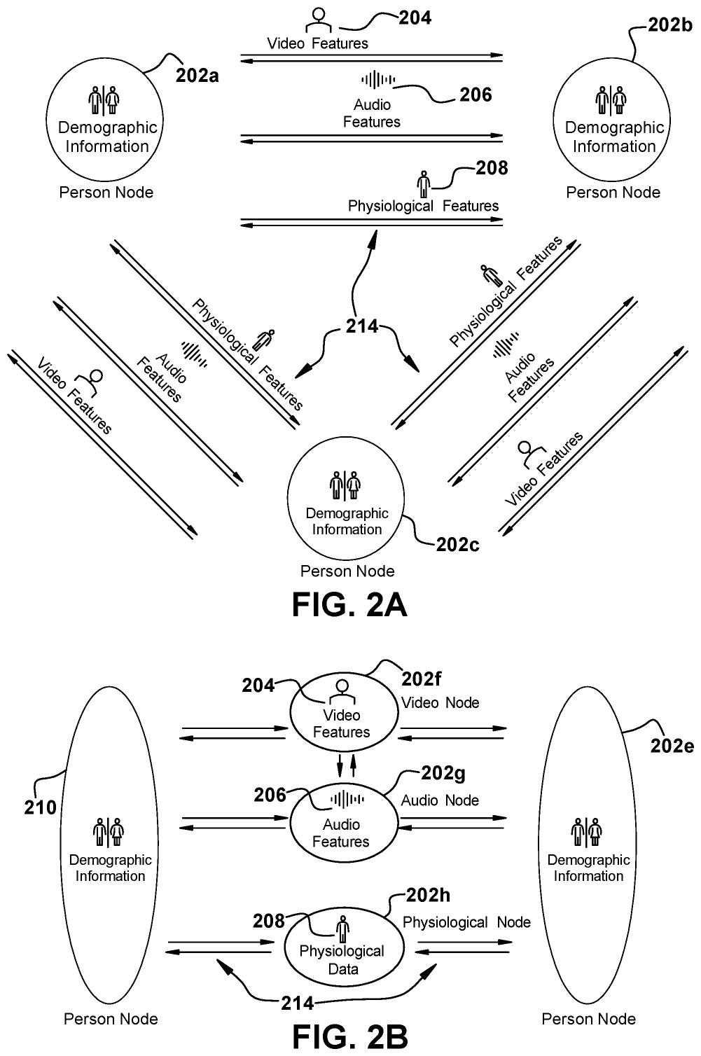

Detailed embodiments describing exemplary graphs 130 generated by the representation module 104 of framework 100 by the system 700 and network configuration discussed above will now be discussed in detail. The example graphs 130 are presented below with respect to FIG. 2A and FIG. 2B and the associated detailed description.

### II. Graphical Representation of Data

Referring now to FIGS. 2A and 2B, exemplary graphs 200, 210 are presented. In a first graph 200, graph nodes 202a, 202b, 202c (collectively nodes 202) are homogenous nodes that are each associated with a person or individual. Each node 202 may include information such as demographic data 210 about the individual that is stored associatively with each node 202. Example demographic data 210 may include any suitable data such as age, height, weight, hair color, facial hair, gender, race, employment information such as position, education, title, type of clothing, glasses or contacts, personal ornamentation such as earrings, tattoos, and so forth.

Graph embeddings 212 between nodes 202 may store data from which relational affect between persons has be determined by suitable algorithms and methods. Example data may include video features 204, for example facial features identified from one or more images where an individual appears in the frame and is facing a camera. For example, individual frames (or images) may be extracted from segments of a video stream and features, such as individuals' facial features, may be analyzed to determine the relational affect between those persons. Multiple frames may be sequentially analyzed to determine temporal changes in relational affect over time, for example over the course of a single conversation or event or longer time frames that may span multiple disparate conversations or events.

Example data may also include audio features 206, from which conversations between people or individual utterances from a person may be extracted from segments of audio. Example data may also include physiological features 208 of one or more people. Example physiological features 208 may be derived from a wearable device on a person. Example wearable devices may include a watch or a fitness device that may provide biometric data such as heart rate, breath rate, AFib detection, indications of movement, and so forth.

In a second graph 210, the nodes 202d, 202e, 202f, 202g, 202h may be heterogeneous. For example, nodes 202d, 202e may be person nodes 202 and are each associated with a person or individual. Nodes 202f, 202g, 202h may be function nodes 202 such as video feature node 202f, an audio feature node 202g, and a physiological data node 202h. The person nodes 202 are associated with the respective function nodes 202 via graph edges 214.

Although the first graph 200 is illustrated as having three nodes 202, and the second graph 210 is illustrated as having two person nodes 202 and three function nodes 202, any suitable number or type of nodes 202 may be used.

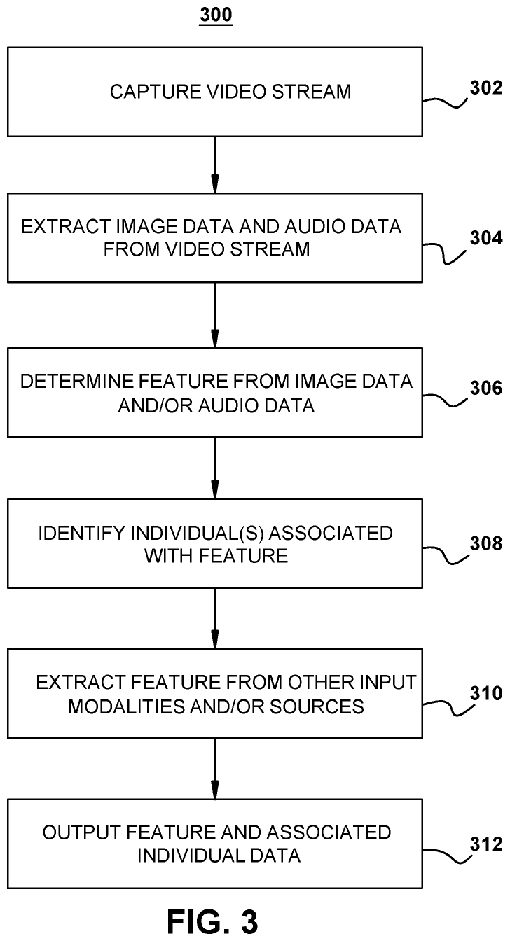

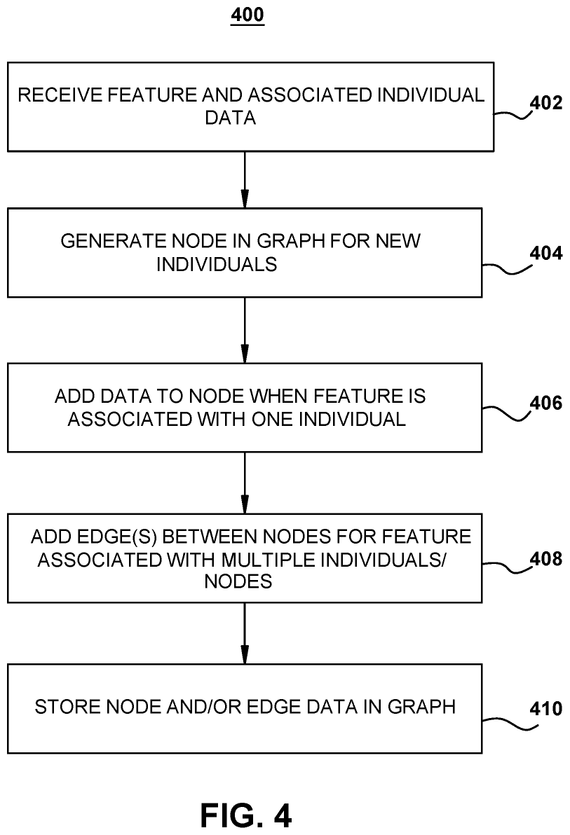

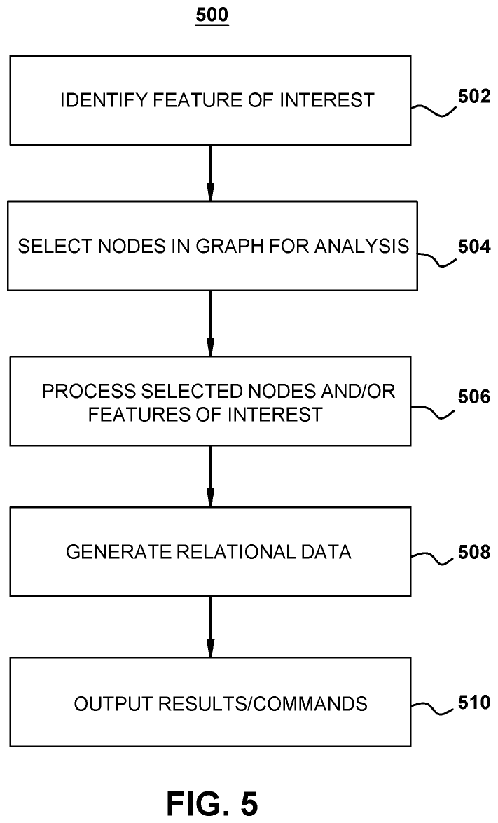

Detailed embodiments describing exemplary methods for graphical representation of data using the graphs and the system and network configuration discussed above will now be discussed in detail. The example methods are presented below with respect to FIG. 3, FIG. 4, FIG. 5 and the associated detailed description.

### III. Methods for Graphical Representation of Data

Referring FIG. 3, FIG. 4, and FIG. 5, the methods 300, 400, 500 will be described as a sequence of elements, but it is understood that the elements of the methods 300, 400, 500 may be organized into different architectures, blocks, stages, and/or processes.

Referring now to FIG. 3, a method 300 is provided for obtaining feature data from one or more input modalities. At block 302, video data is captured, for example from one or more video cameras, streaming camera devices, or from one or more provided video streams. The video data may be a contemporaneous video stream or the video data may be previously recorded video. The video data may include sound and images of one or more social or multi-party interactions, such as conversations between individuals, games played between individuals or teams, sporting events, organizational meetings such as company meetings, and so forth.

At block 304, image data and/or audio data is extracted from the video data. Image data may include a sequence of individual images, or segments of video. Audio data may include segments of audio or an audio stream. The image data and audio data may be transcoded into a suitable format for processing or storage.

At block 306, features are extracted from one or more video data modalities. For example, video features and audio features may be extracted from the image data and audio data. In an embodiment, features may be extracted separately from the image data or audio data, or features may be extracted based on both the image data and the audio data. Features may include, but are not limited to, facial features of individuals captured in the image data, speech or other utterances from individuals, textual translations of spoken words, and holistic video features such as location.

At block 308, features may be optionally extracted from other input data modalities, such as demographic information related to one or more individuals, personal information about an individual which may include identifying features such as an individual's facial features or other appearance related features, and location or biometric information from wearable devices or mobile communication devices.

At block 310, features are identified as being associated with one or more individuals depending on the feature type, the feature itself, and a determined context. For example, demographic features may be associated with an individual or more broadly with a subset or group of individuals, whereas features based on personal information may be associated with just one individual. Some features may be associated with both an individual as well as one or more other individuals depending upon the context. During a conversation, for example, an individual's facial features may be dynamically changing as the conversation progresses. Those facial features would be associated with both parties. However, the individual's facial features could also be associated with just the individual, for example if it were stored personal data used for the purpose of identifying an individual from video data.

In blocks 304-310, features and intermediate data may be determined using any suitable technology, for example trained neural networks or specialized algorithms such facial recognition algorithms, speech to text conversion algorithms, and so forth.

At block 312, the input module transmits feature data, as well as individuals associated with the feature data, to the representation module 104. In an embodiment, the feature data may be sent asynchronously to the representation module 104 as it is developed by the input module. In an embodiment there may be multiple input modules. For example multiple input module instances may be executed to monitor multiple individual video streams.

Referring now also to FIG. 4, a method 400 is provided for storing features in a graph 130. At block 402, one or more features and data identifying associated individuals is received by the representation module 104.

At block 404, a person node in the graph is created for any new individual. Optionally, when the graph is heterogenous then a function node may be created for any new type of feature.

At block 406, feature data associated with a single individual are stored with an associated person node. Optionally, if the graph is heterogeneous then feature data may be stored with an associated function node.

At block 408, feature data associated with two or more individuals are stored as graph embeddings, or edges, between the associated people nodes. Optionally, if the graph is heterogeneous then feature data may be stored as edges between each individual and an associated function node.

At block 410, the updated graph 130 is stored. In an embodiment, storing the updated graph is performed by adding updated nodes and edges to an existing graph 130. If a graph does not yet exist or if a new graph needs to be created, a null graph is first generated and then new nodes and edges are stored in the graph 130.

Referring now also to FIG. 5, a method 500 is provided for analyzing data in the graph 130. At block 502, one or more individuals or features of interest may be selected for analysis. In an embodiment, the entire set of individuals and features of interest may be selected. In an embodiment, a subset of the graph 130 may be selected. In an embodiment, the subset of nodes and edges may be selected based upon any suitable criteria such as a period of time, a particular location, and so forth.

At block 504, the selected individuals and features are analyzed by a suitable geometric deep learning process, a suitable cycling algorithm, or a combination of algorithms and deep learning processes. The data stored in the nodes and edges of the graph 130 facilitates the analysis of relational affect between individuals as well as relational affect within and between groups of individuals. Advantageously, the graph 130 may store data occurring over multiple different periods of time, facilitating the analysis of how relational affect dynamically changes over time. The graph also facilitates analysis based on factors such as location or venue, type of interaction (social, work, sports, etc.), the mix of individuals within a group, and so forth.

At block 506, one or more determinations may be generated based on the analysis in block 504. Example determinations may include predicting group cohesion among a selected group of individuals, determining an individual's membership with one or more groups, accessing leadership skills and effectiveness of individuals with respect to other individuals or groups, and identifying potential interactions to enhance group dynamics.

At block 508, one or more nodes or edges of the graph 130 may be updated based on the analysis and determination operations of blocks 504 and 506. For example, contextual clues derived from the analysis and determination operations may be added to the graph as function nodes or additional edges.

At block 510, tasks derived from the analysis and determination operations may be output to one or more downstream systems. In an embodiment, queries from downstream systems may be received and used as inputs to determine the individuals or features of interest to analyze in the operations of blocks 502 through 508.

### IV. Apparatus and Systems for Graphical Data Representation

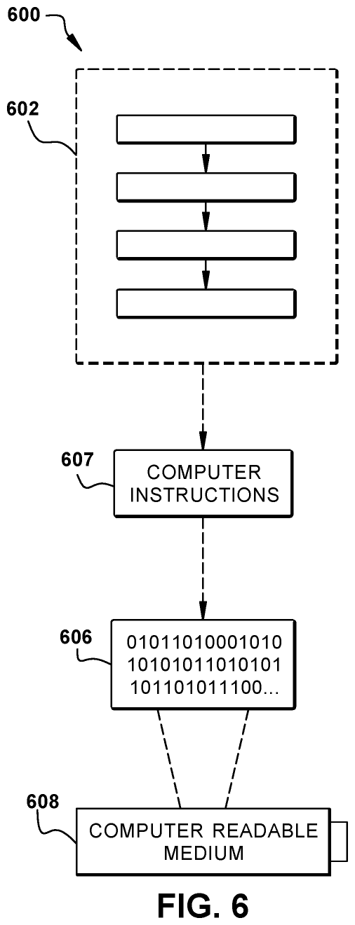

Referring now also to FIG. 6, in another aspect a computer-readable medium including processor-executable instructions configured to implement one aspect of the techniques presented herein. An aspect of a computer-readable medium or a computer-readable device devised in these ways is illustrated wherein an implementation 600 includes a computer-readable medium 608, such as a CD-R, DVD-R, flash drive, a platter of a hard disk drive, etc., on which is encoded computer-readable data 606. This encoded computer-readable data 606, such as binary data including a plurality of zero's and one's as shown in 606, in turn includes a set of processor-executable computer instructions 604 configured to operate according to one or more of the principles set forth herein. In this implementation 600, the processor-executable computer instructions 604 may be configured to perform a method 602, such as the method 300 of FIG. 3, the method 400 of FIG. 4, and/or the method 500 of FIG. 5. In another aspect, the processor-executable computer instructions 604 may be configured to implement a system, such as the operating environment of the framework 100 of FIG. 1. Many such computer-readable media may be devised by those of ordinary skill in the art that are configured to operate in accordance with the techniques presented herein.

As used in this application, the terms “component”, “module,” “system”, “interface”, and the like are generally intended to refer to a computer-related entity, either hardware, a combination of hardware and software, software, or software in execution. For example, a component may be, but is not limited to being, a process running on a processor, a processing unit, an object, an executable, a thread of execution, a program, or a computer. By way of illustration, both an application running on a controller and the controller may be a component. One or more components residing within a process or thread of execution and a component may be localized on one computer or distributed between two or more computers.

Further, the claimed subject matter is implemented as a method, apparatus, or article of manufacture using standard programming or engineering techniques to produce software, firmware, hardware, or any combination thereof to control a computer to implement the disclosed subject matter. The term “article of manufacture” as used herein is intended to encompass a computer program accessible from any computer-readable device, carrier, or media. Of course, many modifications may be made to this configuration without departing from the scope or spirit of the claimed subject matter.

FIG. 7 and the following discussion provide a description of a suitable computing environment to implement aspects of one or more of the provisions set forth herein. The operating environment of FIG. 7 is merely one example of a suitable operating environment and is not intended to suggest any limitation as to the scope of use or functionality of the operating environment. Example computing devices include, but are not limited to, personal computers, server computers, hand-held or laptop devices, mobile devices, such as mobile phones, Personal Digital Assistants (PDAs), media players, and the like, multiprocessor systems, consumer electronics, embedded processors or controllers, mini computers, mainframe computers, distributed computing environments that include any of the above systems or devices, etc.

Generally, aspects are described in the general context of “computer readable instructions” being executed by one or more computing devices. Computer readable instructions may be distributed via computer readable media as will be discussed below. Computer readable instructions may be implemented as program modules, such as functions, objects, Application Programming Interfaces (APIs), data structures, and the like, that perform one or more tasks or implement one or more abstract data types. Typically, the functionality of the computer readable instructions are combined or distributed as desired in various environments.

FIG. 7 illustrates a system 700 including an apparatus 712 configured to implement one aspect provided herein. In one configuration, the apparatus 712 includes at least one processing unit 716 and memory 718. Depending on the exact configuration and type of computing device, memory 718 may be volatile, such as RAM, non-volatile, such as ROM, flash memory, etc., or a combination of the two. This configuration is illustrated in FIG. 7 by dashed line 714.

In other aspects, the apparatus 712 includes additional features or functionality. For example, the apparatus 712 may include additional storage such as removable storage or non-removable storage, including, but not limited to, magnetic storage, optical storage, etc. Such additional storage is illustrated in FIG. 7 by storage 720. In one aspect, computer readable instructions to implement one aspect provided herein are in storage 720. Storage 720 may store other computer readable instructions to implement an operating system, an application program, etc. Computer readable instructions may be loaded in memory 718 for execution by processing unit 716, for example.

The term “computer readable media” as used herein includes computer storage media. Computer storage media includes volatile and nonvolatile, removable and non-removable media implemented in any method or technology for storage of information such as computer readable instructions or other data. Memory 718 and storage 720 are examples of computer storage media. Computer storage media includes, but is not limited to, RAM, ROM, EEPROM, flash memory or other memory technology, CD-ROM, Digital Versatile Disks (DVDs) or other optical storage, magnetic cassettes, magnetic tape, magnetic disk storage or other magnetic storage devices, or any other medium which may be used to store the desired information and which may be accessed by the apparatus 712. Any such computer storage media is part of the apparatus 712.

The term “computer readable media” includes communication media. Communication media typically embodies computer readable instructions or other data in a “modulated data signal” such as a carrier wave or other transport mechanism and includes any information delivery media. The term “modulated data signal” includes a signal that has one or more of its characteristics set or changed in such a manner as to encode information in the signal.

The apparatus 712 includes input device(s) 724 such as keyboard, mouse, pen, voice input device, touch input device, infrared cameras, video input devices, or any other input device. Output device(s) 722 such as one or more displays, speakers, printers, or any other output device may be included with the apparatus 712. Input device(s) 724 and output device(s) 722 may be connected to the apparatus 712 via a wired connection, wireless connection, or any combination thereof. In one aspect, an input device or an output device from another computing device may be used as input device(s) 724 or output device(s) 722 for the apparatus 712. The apparatus 712 may include communication connection(s) 726 to facilitate communications with one or more other computing devices 730, such as through network 728, for example. The communication connection 726 provides software and hardware to facilitate data input and output between the components of the apparatus 712 and other components, networks, and data sources, as described herein. The network 728 may be, for example, a data network, the Internet, a wide area network (WAN) or a local area (LAN) network. The network 728 serves as a communication medium to various remote devices (e.g., databases, web servers, remote servers, application servers, intermediary servers, client machines, other portable devices).

Although the subject matter has been described in language specific to structural features or methodological acts, it is to be understood that the subject matter of the appended claims is not necessarily limited to the specific features or acts described above. Rather, the specific features and acts described above are disclosed as example aspects. Various operations of aspects are provided herein. The order in which one or more or all of the operations are described should not be construed as to imply that these operations are necessarily order dependent. Alternative ordering will be appreciated based on this description. Further, not all operations may necessarily be present in each aspect provided herein.

As used in this application, “or” is intended to mean an inclusive “or” rather than an exclusive “or”. Further, an inclusive “or” may include any combination thereof (e.g., A, B, or any combination thereof). In addition, “a” and “an” as used in this application are generally construed to mean “one or more” unless specified otherwise or clear from context to be directed to a singular form. Additionally, at least one of A and B and/or the like generally means A or B or both A and B. Further, to the extent that “includes”, “having”, “has”, “with”, or variants thereof are used in either the detailed description or the claims, such terms are intended to be inclusive in a manner similar to the term “comprising”.

Further, unless specified otherwise, “first”, “second”, or the like are not intended to imply a temporal aspect, a spatial aspect, an ordering, etc. Rather, such terms are merely used as identifiers, names, etc. for features, elements, items, etc. For example, a first channel and a second channel generally correspond to channel A and channel B or two different or two identical channels or the same channel. Additionally, “comprising”, “comprises”, “including”, “includes”, or the like generally means comprising or including, but not limited to.

It will be appreciated that several of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A system for generating a graph of group affect, comprising:
an image processor configured to:
receive video of a group of individuals from a video source,
extract a feature from the video, and
identify an individual from the group associated with the feature; and
a graph module configured to:
determine when a node in a graph is associated with the individual, and
store the feature associatively with the node in the graph when the feature is associated only with the individual,
wherein the feature includes data for determining group affect, and
wherein the graph includes
a plurality of nodes where at least one node is associated with one individual, and
a plurality of edges between nodes where each edge is associated with a feature.

2. The system of claim 1, wherein the video source is selected from the group consisting of a video camera, a video streaming device, a pre-recorded video, and a segment of a video.

3. The system of claim 1, wherein the graph module is further configured to
generate a new node in the graph when no node is associated with the individual,
associate the new node in the graph with the individual, and
store the feature associatively with the new node in the graph.

4. The system of claim 1, wherein at least one node is associated with a feature.

5. The system of claim 1, wherein the image processor is further configured to identify a second individual associated the feature; and
wherein the graph module is further configured to
determine a second node associated with the second individual,
generate an edge associated with the node and the second node, and
store the feature associatively with the edge in the graph.

6. The system of claim 1, wherein the graph module is further configured to process the graph to determine at least one group affect associated with at least two individuals from the group.

7. The system of claim 6, wherein the graph module is further configured to store the determined group affect associatively with an edge of the graph.

8. A method for generating a graph of group affect, comprising:
receiving, by an image processor, video of a group of individuals from a video source;
extracting, by the image processor, a feature from the video;
identifying an individual from the group that is associated with the feature;
determining, by a graph module, when a node in a graph is associated with the individual; and
storing, by the graph module, the feature associatively with the node in the graph when the feature is associated only with the individual,
wherein the feature includes data for determining group affect, and
wherein the graph includes
a plurality of nodes where at least one node is associated with one individual, and
a plurality of edges between nodes where each edge is associated with a feature.

9. The method of claim 8, wherein the video source is selected from the group consisting of a video camera, a video streaming device, a pre-recorded video, and a segment of a video.

10. The method of claim 8, further comprising:
generating a new node in the graph when no node is associated with the individual;
associating the new node in the graph with the individual; and
storing the feature associatively with the new node in the graph.

11. The method of claim 8, wherein at least one node is associated with a feature.

12. The method of claim 8, further comprising:
identifying a second individual associated the feature;
determining a second node associated with the second individual;
generating an edge associated with the node and the second node; and
storing the feature associatively with the edge in the graph.

13. The method of claim 8, further comprising:
processing the graph to determine at least one group affect associated with at least two individuals from the group.

14. The method of claim 13, further comprising:
storing the determined group affect associatively with an edge of the graph.

15. A non-transitory computer readable storage medium storing instructions that when executed by a computer having a processor to perform a method for generating a graph of group affect, the method comprising:
receiving video of a group of individuals from a video source;
extracting a feature from the video source;
identifying an individual from the group that is associated with the feature;
determining whether a node in a graph is associated with the individual; and
storing the feature associatively with the node in the graph
when the feature is associated only with the individual and
when the node is associated with the individual,
wherein the feature includes data for determining group affect, and
wherein the graph includes
a plurality of nodes where at least one node is associated with one individual, and
a plurality of edges between nodes where each edge is associated with a feature.

16. The non-transitory computer readable storage medium of claim 15, wherein the video source is selected from the group consisting of a video camera, a video streaming device, a pre-recorded video, and a segment of a video.

17. The non-transitory computer readable storage medium of claim 15, wherein the processor is further configured to
generate a new node in the graph when no node is associated with the individual;
associate the new node in the graph with the individual; and
store the feature associatively with the new node in the graph.

18. The non-transitory computer readable storage medium of claim 17, wherein at least one node is associated with a feature.

19. The non-transitory computer readable storage medium of claim 15, wherein the processor is further configured to
identify a second individual associated with individual and the associated feature;
determine second node associated with the second individual;
generate an edge associated with the node and the second node; and
store the feature associatively with the edge in the graph.

20. The non-transitory computer readable storage medium of claim 15, wherein the processor is further configured to
process the graph to determine at least one group affect associated with at least two individuals from the group; and
store the determined group affect associatively with an edge of the graph.
